(19) United States
(12) Patent Application Publication
(10) Pub. No.: US 2013/0187738 A1
(43) Pub. Date: Jul. 25, 2013

(54) ELECTRICAL APPARATUS HAVING A THERMALLY CONDUCTIVE BOBBIN

(71) Applicants: Debabrata Pal, Hoffman Estates, IL (US); John Huss, Roscoe, IL (US); Richard L. Downing, Loves Park, IL (US); Frank Z. Feng, Loves Park, IL (US)

(72) Inventors: Debabrata Pal, Hoffman Estates, IL (US); John Huss, Roscoe, IL (US); Richard L. Downing, Loves Park, IL (US); Frank Z. Feng, Loves Park, IL (US)

(73) Assignee: HAMILTON SUNDSTRAND CORPORATION, Windsor Locks, CT (US)

(21) Appl. No.: 13/355,810

(22) Filed: Jan. 23, 2012

(51) Int. Cl. H01F 27/08; H01F 41/06; H01F 41/12; H01F 17/04

(52) U.S. Cl. 336/61; 336/221; 29/605

(57) ABSTRACT

An electrical apparatus includes a magnetic core, and a bobbin extending about and partially covering the magnetic core. The bobbin is formed from a thermally conductive material. An electrical conductor forms a winding that wraps about the bobbin.

### BACKGROUND OF THE INVENTION

Illustrative embodiments pertain to the art of electrical apparatuses and, more particularly, to an electrical apparatus having a thermally conductive bobbin.

A transformer is an electric apparatus that transforms voltage and/or current at one level to voltage and/or current at one or more other levels. An autotransformer is an electrical transformer having a single winding. The single winding acts as both a primary and a secondary. Accordingly, the single winding includes at least three taps or terminals for external connections. The taps or terminals include first and second end terminals and one or more intermediate terminals. The single winding is wrapped about magnetic core. A bobbin, formed from a non-electrically conductive material, insulates the windings from the core. Typically, the bobbin is formed from high temperature engineering plastics.

### BRIEF DESCRIPTION OF THE INVENTION

Disclosed is an electrical apparatus including a magnetic core, and a bobbin extending about and partially covering the magnetic core. The bobbin is formed from a thermally conductive material. An electrical conductor forms a winding that wraps about the bobbin.

Also disclosed is a method of forming an electrical apparatus. The method includes forming a bobbin from a thermally conductive material, providing a magnetic core within the bobbin, and winding an electrical conductor about the bobbin.

### BRIEF DESCRIPTION OF THE DRAWINGS

The following descriptions should not be considered limiting in any way. With reference to the accompanying drawings, like elements are numbered alike:

FIG. 1 is a perspective view of a transformer including a bobbin formed in accordance with an illustrated embodiment;

FIG. 2 is an elevational view of a bobbin in accordance with an illustrated embodiment;

FIG. 3 is a perspective view of the bobbin of FIG. 2 lacking any coating or covering film;

FIG. 4 is a perspective view of the bobbin of FIG. 3 including a hard anodized coating;

FIG. 5 is a perspective view of the bobbin of FIG. 4 including a covering of thermally conductive and electrically insulating film;

FIG. 6 is a partial perspective view of a bobbin including corrugations in accordance with another aspect of the exemplary embodiment;

FIG. 7 is a partial perspective view of a bobbin including integrated cooling channels in accordance with another aspect of the exemplary embodiment; and

FIG. 8 is a bobbin formed from a thermally conductive material in accordance with another aspect of the exemplary embodiment.

### DETAILED DESCRIPTION OF THE INVENTION

A detailed description of one or more embodiments of the disclosed apparatus and method are presented herein by way of exemplification and not limitation with reference to the Figures.

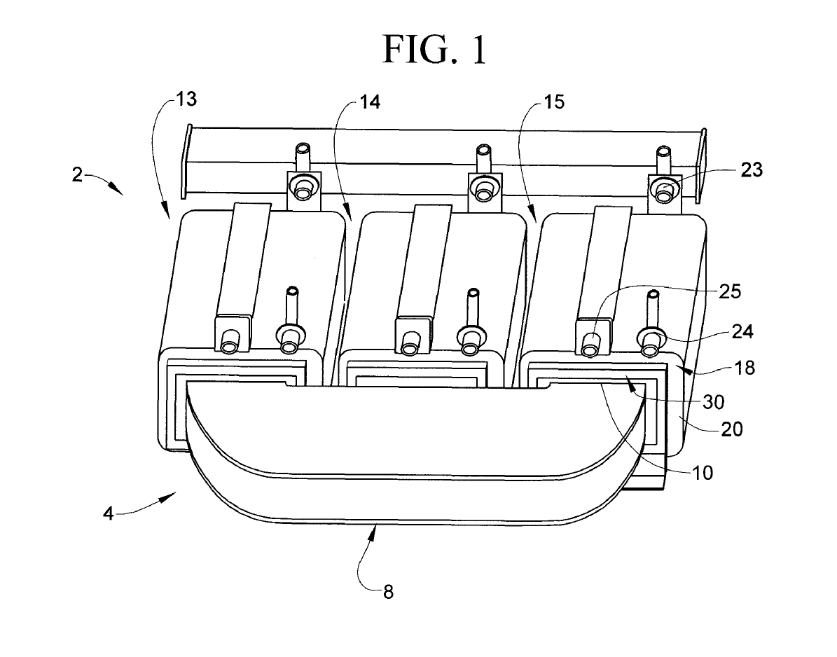

As best shown in FIG. 1, an electrical apparatus in accordance with an illustrative embodiment is indicated generally at 2. Electrical apparatus 2 takes the form of a three phase transformer 4. It should be understood that the number of phases could vary. It should also be understood that electrical apparatus 2 can take on a variety of forms including transformers, inductors and the like. Transformer 4 is shown as an autotransformer. Transformer 4 includes a magnetic core 8 having a plurality of core members one of which is indicated at 10. Each core member 10 defines first, second, and third coils 13, 14, and 15. As each coil 13-15 is substantially the same, a detailed description will follow with reference to coil 15 with an understanding that coils 13 and 14 include similar structure. Coil 15 includes a winding 18 that is formed from an electrical conductor 20. In accordance with one aspect of the exemplary embodiment, electrical conductor 20 is a continuous conductor having a first end 23 that forms a first terminal, a second end 24 that forms a second terminal, and an intermediate portion 25 that forms a third terminal. It should however be understood that electrical conductor 20 can take on a variety of forms including multiple winding layers formed by foils, single stranded or multi-stranded wire. The number of terminals along intermediate portion 25 can vary. Conductor 20 is wrapped around a bobbin 30 and covered with an insulating wrap (not separately labeled).

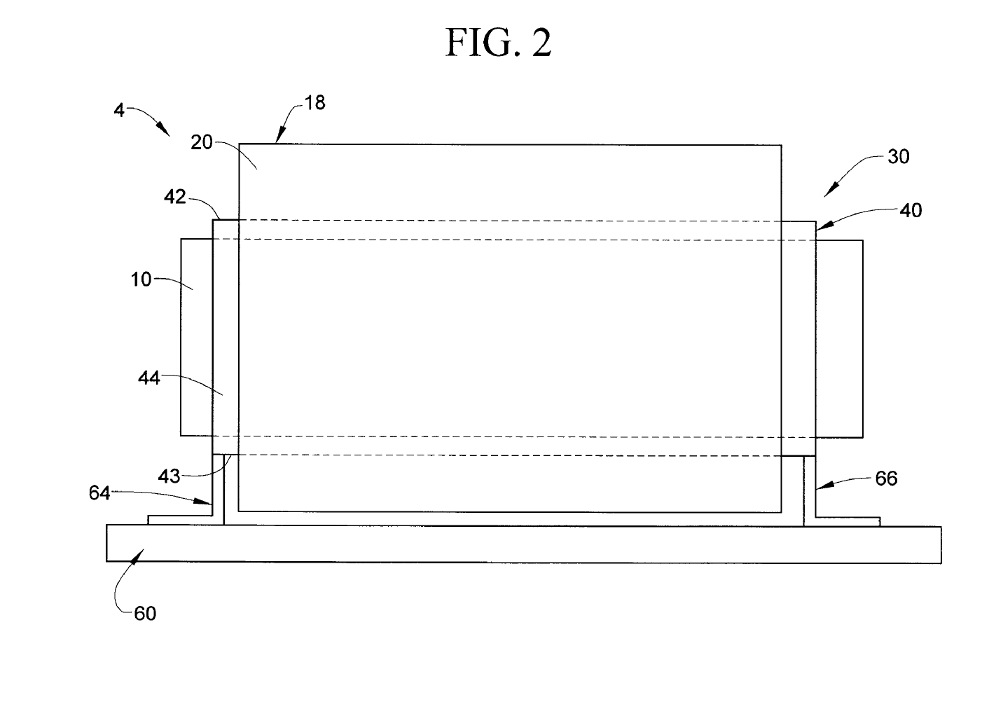

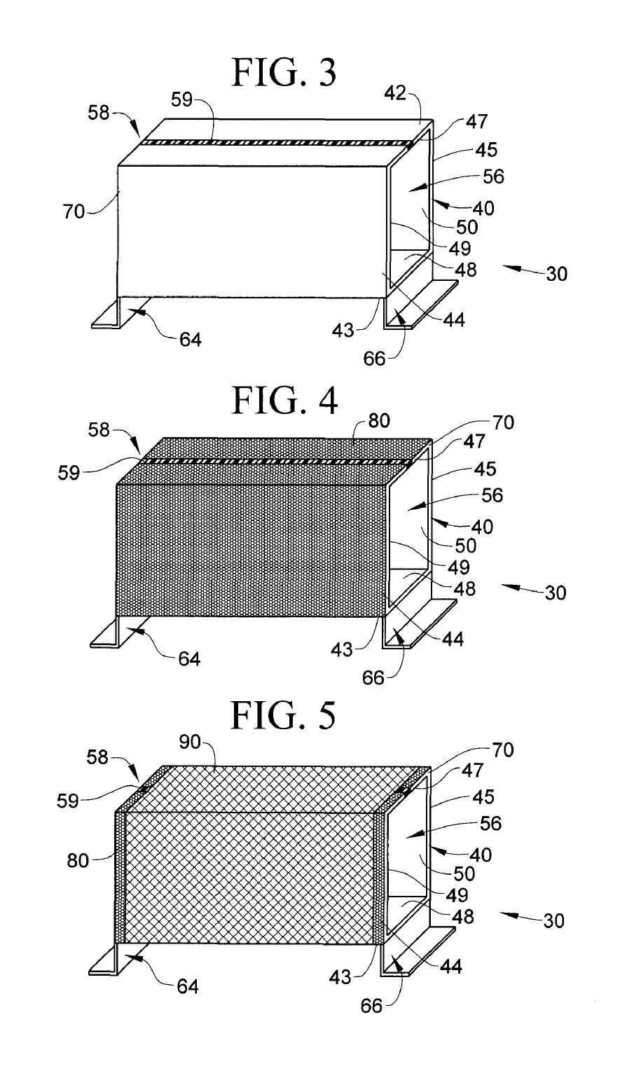

Reference will now be made to FIGS. 2 and 3 in describing bobbin 30 in accordance with an illustrative embodiment. Bobbin 30 includes a main body 40 having a plurality of outer surfaces 42, 43, 44, and 45, and a plurality of inner surfaces 47, 48, 49, and 50 that collectively define a core member receiving passage 56. In the embodiment shown, a discontinuity 58 is formed in bobbin 30. Discontinuity 58 extends from outer surface 42 through inner surface 47. Discontinuity 58 provides an interruption to electrical current flow that may pass through bobbin 30. Towards that end, discontinuity 58 is filled with an electrically insulative material 59. The size and shape of discontinuity 58 as well as the type of electrically insulative material 59 may vary. It should also be understood that electrically insulative material 59 may comprise an air gap.

Bobbin 30 is mounted to a thermally conductive plate or cold plate 60 that is in a heat transfer relationship with main body 40. The thermally conductive plate 60 may also be referred to as a heat exchange plate 60. The thermally conductive plate 60 may also be referred to as heat exchange plate 60. More specifically, main body 40 is coupled to thermally conductive plate 60 through first and second bobbin flanges 64 and 66. Bobbin flanges 64 and 66 provide a thermal or conductive flow path that facilitates heat transfer between main body 40 and thermally conductive plate 60. In accordance with the illustrated embodiment, bobbin 30 is formed from a thermally conductive material 70. Thermally conductive material 70 takes the form of an electrically conductive material such as a metal. In accordance with one aspect of the illustrated embodiment, thermally conductive material 70 is aluminum. In accordance with another aspect of the illustrated embodiment, thermally conductive material 70 takes the form of aluminum 6061.

In accordance with one aspect of the illustrated embodiment, bobbin 30 is provided with a hard anodized coating 80 as shown in FIG. 4. Hard anodized coating 80 provides an electrically insulating layer between bobbin 30 and electrical conductor 20. In accordance with one aspect of the illustrated embodiment, hard anodized coating 80 includes an oxide. In accordance with another aspect of the illustrated embodiment, hard anodized coating 80 includes an aluminum oxide. Aluminum oxide not only provides electrical insulation but also enhances thermal conductivity between electrical conductor 20 and bobbin 30. At this point it should be understood that the use of hard anodized coating 80 may be omitted and bobbin 30 simply covered with an electrically resistive film 90 as discussed more fully below.

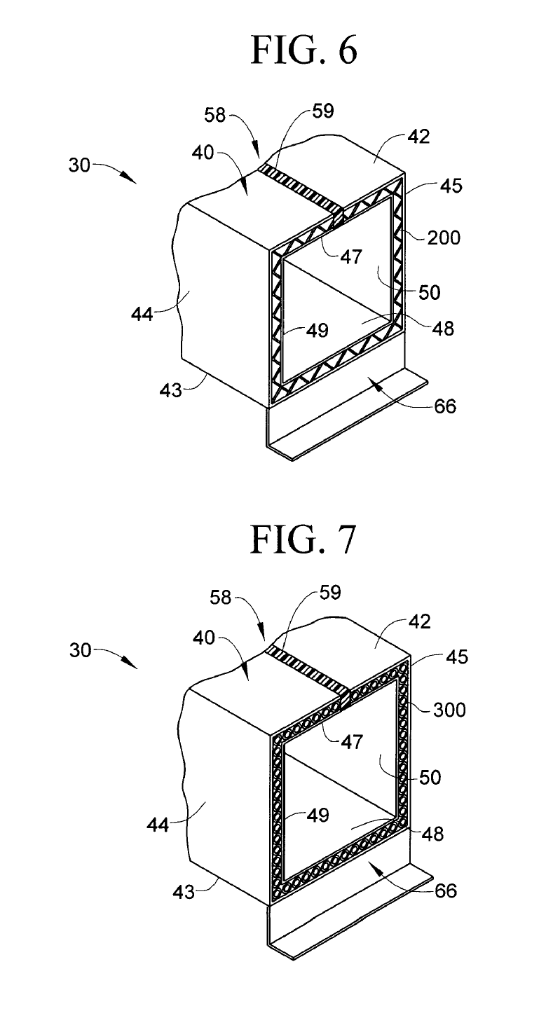

Electrically resistive film 90 enhances dielectric strength while having a negligible effect on thermal conductivity. In accordance with one aspect of the illustrated embodiment, electrically resistive film 90 takes the form of a polyimide film. In accordance with another aspect of the illustrated embodiment, the polyimide film may take the form of KAPTON® made by the DuPont Corporation. The addition of electrically resistive film 90 promotes dielectric strength between electrical conductor 20 and bobbin 30. In addition, bobbin 30 may be provided with plurality of corrugations 200 (FIG. 6) to further increase heat transfer. Bobbin 30 may alternatively be provided with heat pipes 300 that extend through main body 40. Heat pipes 300 may conduct a fluid through main body 40 to transfer heat from bobbin 30.

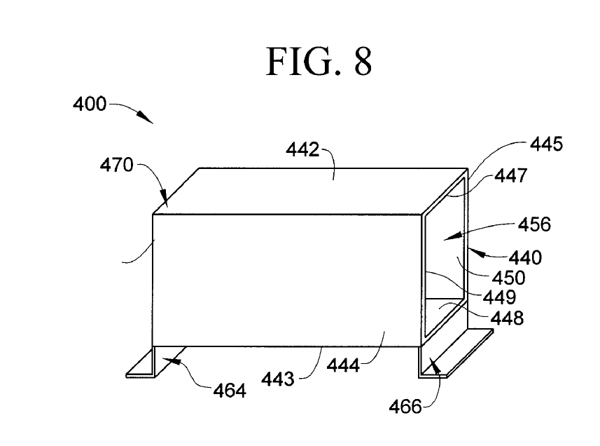

FIG. 8 illustrates a bobbin 400 formed in accordance with another aspect of the exemplary embodiment. Bobbin 400 includes a main body 440 having a plurality of outer surfaces 442, 443, 444, and 445, and a plurality of inner surfaces 447, 448, 449, and 450 that collectively define a core member receiving passage 456. Bobbin 400 is mounted to a thermally conductive heat transfer relationship with cold plate 60. More specifically, main body 440 is coupled to thermally conductive plate 60 through first and second bobbin flanges 464 and 466. Bobbin flanges 464 and 466 provide a conductive flow path that facilitates heat transfer between main body 440 and thermally conductive plate 60. In accordance with the illustrated embodiment, bobbin 400 is formed from a thermally conductive and electrically resistive material 470. In accordance with one aspect of the exemplary embodiment, thermally conductive and electrically resistive material 470 takes the form of a ceramic such as Aluminum oxide, Aluminum Nitride, Boron Nitride or the like. Of course, other material that possesses thermally conductive and electrically insulative properties could also be employed.

At this point it should be understood that the illustrated embodiments provide a system for more effectively conducting heat from a transformer bobbin. That is, in contrast to prior art bobbins formed from plastics and other electrically insulating materials that have poor heat conducting properties, the bobbin of the illustrated embodiment is formed from a material that conducts heat away from transformer windings. The enhanced thermal conductively leads to a reduction in winding and core temperatures in the transformer. It has been shown that the illustrated embodiments can lower winding and core temperatures by about 10° C. or more. This temperature reduction leads to efficiency gains from the transformer. It should also be understood that while shown and described in connection with an autotransformer, the bobbin of the present invention may be used in other types of transformers, inductors or other magnetic assemblies.

While the invention has been described with reference to an illustrated embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. An electrical apparatus comprising:
a magnetic core;
a bobbin extending about and partially covering the magnetic core, the bobbin being formed from a thermally conductive material; and
an electrical conductor forming a winding that wraps about the bobbin.

2. The electrical apparatus according to claim 1, further comprising:
a heat exchange plate that supports the bobbin and in a heat exchange relationship therewith.

3. The electrical apparatus according to claim 2, wherein the bobbin includes at least one flange member that connects the bobbin to the heat exchange plate.

4. The electrical apparatus according to claim 1, wherein the thermally conductive material is an electrically conductive material.

5. The electrical apparatus according to claim 4, wherein the electrically conductive material is an aluminum.

6. The electrical apparatus according to claim 4, wherein the bobbin includes a main body having a plurality of outer surfaces and a plurality of inner surfaces and a discontinuity extending through at least one of the outer surfaces and corresponding one of the inner surfaces.

7. The electrical apparatus according to claim 6, wherein the discontinuity is filled with an electrically insulative material.

8. The electrical apparatus according to claim 4, further comprising:
an electrically insulative film covering the bobbin.

9. The electrical apparatus according to claim 8, wherein the electrically insulative film comprises a polyimide film.

10. The electrical apparatus according to claim 1, wherein the thermally conductive material is a ceramic.

11. The electrical apparatus according to claim 1, wherein the bobbin includes a main body having a plurality of outer surfaces and a plurality of inner surfaces, at least one of the plurality of outer surfaces and the plurality of inner surfaces including a plurality of corrugations.

12. The electrical apparatus according to claim 1, wherein the bobbin includes a main body and a plurality of heat pipes extending through the main body.

13. A method of forming an electrical apparatus comprising:
forming a bobbin from a thermally conductive material;
providing a magnetic core within the bobbin; and
winding an electrical conductor about the bobbin.

14. The method of claim 13, wherein forming the bobbin from a thermally conductive material includes forming the bobbin from an electrically conductive material.

15. The method of claim 14, further comprising: forming a discontinuity in one surface of the bobbin.

16. The method of claim 15, further comprising: wrapping the bobbin with an electrically insulative film.

17. The method of claim 13, wherein forming the bobbin from a thermally conductive material includes forming the bobbin from a ceramic.

18. The method of claim 13, further comprising:
mounting the bobbin to a thermally conductive plate.

19. The method of claim 13, further comprising:
mounting the bobbin to the thermally conductive plate through first and second flange members, the first and second flange members establishing a thermal path between the bobbin and the thermally conductive plate.

20. The method of claim 13, wherein winding the electrical conductor about the bobbin includes winding a single continuous electrical conductor having a first end portion, a second end portion and an intermediate portion about the bobbin, wherein the first end portion defines a first terminal, the second end portion defines a second terminal, and a third terminal is provided at the intermediate portion.
